(19) United States
(12) Patent Application Publication
(10) Pub. No.: US 2001/0050358 A1
(43) Pub. Date: Dec. 13, 2001

(54) Garage jack

(75) Inventors: Hiroyoshi Tominaga, Tokyo (JP); Yaichi Sawai, Tokyo (JP); Hisashi Asano, Tokyo (JP)

Correspondence Address: SUGHRUE, MION, ZINN, MACPEAK & SEAS, 2100 Pennsylvania Avenue, N.W., Washington, DC, 20037, US

(73) Assignee: MASADA SEISAKUSHO CO., LTD.

(21) Appl. No.: 09/866,653

(22) Filed: May 30, 2001

(30) Foreign Application Priority Data
Jun. 12, 2000 (JP) 2000-175037
Mar. 7, 2001 (JP) 2001-063560

(51) Int. Cl. B66F 3/00

(52) U.S. Cl. 254/8 B

(57) ABSTRACT

The present invention provides a garage jack provided with a dual cylinder mechanism for rapid traversing in which there is no fear that damage will be caused by an accidental load during rapid traverse and working of a hydraulic circuit is simple. The garage jack comprises, a movable frame provided with wheels, an arm pivotably supported at the frame and having a support plate at an end thereof, a hydraulic cylinder (9) for operating the arm up-and-down, the hydraulic cylinder (9) comprising a dual cylinder mechanism comprising a low pressure chamber (15) of a small effective cross-sectional area relative to a piston (8) and a high pressure chamber (16) of a large effective cross-sectional area, a pump cylinder (10) for supplying hydraulic fluid to the hydraulic cylinder and a handle (13) for operating the pump cylinder wherein, a hydraulic fluid channel (27) provided with a sequence valve (19) is provided connected in-line with the low pressure chamber (15) and the high pressure chamber (16) and in a case where a pressure of hydraulic fluid in the low pressure chamber is greater than a predetermined pressure of the sequence valve, the hydraulic fluid in the low pressure chamber is fed to the high pressure chamber.

### BACKGROUND OF THE INVENTION

(a) Field of the Invention

The present invention relates to a garage jack used for raising or lowering automotive vehicles such as passenger cars and trucks when performing maintenance or repair, and, in particular to a garage jack including a movable frame equipped with wheels, an arm pivotably supported at the frame and having a support plate at an end thereof and a hydraulic cylinder for operating the arm up-and-down, a pump cylinder for supplying hydraulic fluid to the hydraulic cylinder and a handle for operating the pump cylinder.

(b) Description of the Related Art

As shown in FIG. 4, a conventional garage jack such as above includes a movable frame 1 equipped with wheels 2, an arm 5 supported at the frame by means of a pivot 3 and having a support plate 4 at an end thereof, a link rod 6 for assisting actuation of the arm 5 pivotably attached to the frame 1, a hydraulic cylinder 9 provided with a piston rod 8 of which a tip is connected to a base 7 of the arm 5, a pump cylinder 10 for supplying hydraulic fluid to the hydraulic cylinder 9 and a handle 13 for operating the pump cylinder 10 via links 11, 12.

The handle 13 is operated by human power to operate the pump cylinder 10 via the links 11, 12, and the hydraulic cylinder 9 is operated by hydraulic fluid from the pump cylinder 10. The arm 5 is raised to raise the support plate 4 and an object to be lifted, an automotive vehicle, is lifted. Also, the raised vehicle can be lowered by evacuating hydraulic fluid from the relief valve of the hydraulic circuit (see Japanese Patent Laid-open No. Hei 10-33090).

Incidentally, when raising or lowering an object to be lifted, an automotive vehicle, with this type of garage jack, the support plate must be properly set to a jack point (for example, a differential, axle, etc.) located at the underside of an automotive vehicle in order to safely support the vehicle. Moreover, in order for a support plate to be properly set, it is necessary to slide the frame of the garage jack beneath the vehicle and position the support plate directly underneath the jack point.

Accordingly, the height of this type of garage jack is limited by the height from the ground to the lowest part of a vehicle, that is, by the ground clearance of the automotive vehicle, and the garage jack should be constructed to be as low as possible. For example, in the garage jack disclosed in the above Japanese Patent Application Laid-open No. Hei 10-33090, the arm 5, link rod 6 and hydraulic cylinder 9 are arranged in-line horizontally so that it may be used even on cars that are very low to the ground. Also, as shown in FIG. 5, a compact structure is also already known from Japanese Patent Application Laid-open No. Hei 10-33090 in which it is possible to dispose the hydraulic cylinder 9 below the arm 5 and operate the arm 5 provided with the support plate 4 at an end thereof through a link 14.

As can be seen from the above, in this type of garage jack, the height is limited by the ground clearance of the automotive vehicle because, especially when lifting, the frame must be slid underneath the object to be lifted, the automotive vehicle. And when the diameter of the hydraulic cylinder is increased to increase the output of the garage jack, the number of automotive vehicles on which the jack can be used is severely limited.

Accordingly, in this type of garage jack, efforts have been made to increase the pressure in the hydraulic cylinder in order to obtain a large output. However, the operating force of the pump cylinder is generally limited because its operation is performed by human power, and since it is necessary to prevent the diameter of the pump cylinder from being small compared to the diameter of the hydraulic cylinder, the operating frequency of the pump piston increases remarkably when creating a high pressure in the hydraulic cylinder.

Incidentally, since only the arm is lifted in the operation of contacting the support plate of the garage jack to the vehicle jack point, and this load may be substantially ignored, the output of the hydraulic cylinder may be very low. That is, since the operation of raising the arm from the lowest height of the support plate to the jack point is not the originally intended use of the garage jack, that is, lifting an automotive vehicle, but is preliminary work which is supplementary thereto, decreasing the frequency of operation of the handle for operating the pump cylinder to operate the arm greatly enhances the convenience of the garage jack.

A garage jack provided with, as a means for eliminating the increased frequency of operation of the handle, a dual cylinder mechanism, that is, a dual cylinder mechanism including a low pressure chamber for rapid traversing having a small effective cross-sectional area relative to a piston and a high pressure chamber for normal operation having a large effective cross-sectional area for reducing the operating frequency of the handle during the substantially no-load operation of raising the support plate from its lowest position to the jack point has already been disclosed in U.S. Pat. No. 5,755,099.

Namely, as shown in FIG. 6, a hydraulic cylinder 9 is a dual cylinder mechanism including an inner cylinder being a low pressure chamber 15 of a small effective cross-sectional area relative to a piston 8 and an outer cylinder being a high pressure chamber 16 of a large effective cross-sectional area, hydraulic fluid pumped by means of the pump cylinder 10 is divided into two channels 17, 18 toward the low pressure chamber 15 and high pressure chamber 16, respectively, and a check valve 25 for preventing reverse flow is provided in the hydraulic fluid channel 17 leading to the low pressure chamber 15 and a sequence valve 19 is provided in the hydraulic fluid channel 18 leading to the high pressure chamber 16. Hydraulic fluid is allowed to flow to the high pressure chamber 16 in a case where the pressure in the hydraulic fluid channel 18 is greater than a predetermined pressure of the sequence valve 19.

Accordingly, during the substantially no-load operation of raising the arm from the lowest position of the support plate to the jack point, hydraulic fluid is first pumped to the low pressure chamber 15 of a small effective cross-sectional area via the hydraulic fluid channel 17 to rapidly operate the piston 8 of the hydraulic cylinder 9 and quickly raise the arm provided with the support plate. The arm rises and when the support plate of the arm reaches jack point, operation becomes a load condition of lifting the object to be lifted, the automotive vehicle. That is, the pressure of the hydraulic fluid in the low pressure chamber 15 increases and the pressure of hydraulic fluid pumped by the pump cylinder 10 exceeds a preset pressure of the sequence valve 19, and the sequence valve 19 opens and hydraulic fluid is pumped to the high pressure chamber 16. Thus, the piston 8 operates slowly, but the output thereof is very large and it is possible to lift the object to be lifted, the automotive vehicle.

A hydraulic circuit provided with a check valve 20 for preventing reverse flow is provided between the high pressure chamber 16 and an oil tank 21. When hydraulic fluid is pumped to the low pressure chamber 15 only to operate the piston 8, hydraulic fluid may be sucked into the high pressure chamber 16 from the oil tank 21 via the check valve 20 so that a vacuum is not caused in the high pressure chamber 16. Also, a safety valve 22 prevents an overpressure in the hydraulic circuit and a relief valve 23 returns oil in the hydraulic cylinder 9 and each hydraulic circuit to the oil tank 21. Moreover, a check valve 24 operates to pump up hydraulic fluid from the oil tank 21.

The garage jack provided with the above dual cylinder mechanism in which, hydraulic fluid pumped by means of the pump cylinder is divided into two channels leading toward the low pressure chamber and high pressure chamber, respectively, and the check valve for preventing reverse flow is provided in the hydraulic fluid channel leading to the low pressure chamber 15, is designed to positively feed hydraulic fluid to the low pressure chamber. Thus, when an accidental load occurs on the arm provided with the support plate during rapid traverse, that is, when hydraulic fluid is supplied to the low pressure chamber, high pressure develops in the hydraulic fluid in the low pressure chamber and there is a concern that components of the low pressure chamber or the hydraulic fluid channel leading to the low pressure chamber may become damaged. Also, because the sequence valve provided in the hydraulic fluid channel leading to the high pressure chamber is provided in a bed of the garage jack and the sequence valve, check valves and the like are concentrated in the bed of the garage jack, the hydraulic circuit becomes very complicated and fabrication of the hydraulic circuit in the bed is very difficult.

### SUMMARY OF THE INVENTION

The present invention aims to solve the above problems with the conventional art and an object of the present invention is to provide a garage jack in which a hydraulic circuit may be simply fabricated and in which there is no concern that damage will be caused due to an accidental load during rapid traverse.

In order to achieve the above mentioned object, according to one aspect of the present invention there is provided a garage jack including, a movable frame provided with wheels, an arm pivotably supported at the frame and having a support plate at an end thereof, a hydraulic cylinder for operating the arm up-and-down, the hydraulic cylinder including a dual cylinder mechanism including a low pressure chamber of a small effective cross-sectional area relative to a piston and a high pressure chamber of a large effective cross-sectional area, a pump cylinder for supplying hydraulic fluid to the hydraulic cylinder and a handle for operating the pump cylinder wherein, a hydraulic fluid channel provided with a sequence valve is provided connected in-line with the low pressure chamber and the high pressure chamber and in a case where a pressure of hydraulic fluid in the low pressure chamber is greater than a predetermined pressure of the sequence valve, the hydraulic fluid in the low pressure chamber is fed to the high pressure chamber.

According to another aspect of the present invention the hydraulic fluid channel provided with the sequence valve provided connected in-line with the low pressure chamber and the high pressure chamber may be preferably disposed in the piston of the hydraulic cylinder. In this case, the sequence valve may preferably include a stepped opening formed in the piston of the hydraulic cylinder, packing for sealing between the stepped opening and a hydraulic fluid supply pipe, and a spring for pressing the packing to a step portion of the stepped opening. Also, a hydraulic circuit provided with a check valve may be preferably provided between the high pressure chamber and an oil tank for preventing a vacuum in the high pressure chamber.

### BRIEF DESCRIPTION OF THE DRAWINGS

FIG. 1 is circuit diagram of a hydraulic circuit of a garage jack according to the present invention.

FIG. 2 is a cross-sectional drawing of an essential portion of an example of a sequence valve of a garage jack according to the present invention.

FIG. 3(A) is a plan view of packing of the sequence valve of FIG. 2; FIG. 3(B) is a plan view of the presser bar 32 of the sequence valve of FIG. 2.

FIG. 4 is an explanatory drawing of a conventional garage jack.

FIG. 5 is an explanatory drawing of another conventional garage jack.

FIG. 6 is circuit diagram of a hydraulic circuit of yet another conventional garage jack.

### DETAILED DESCRIPTION OF THE PREFERRED EMBODIMENTS

Preferred embodiments of the garage jack of the present invention will be described below with reference to the drawings. Moreover, similar or corresponding portions are denoted by the same reference numerals.

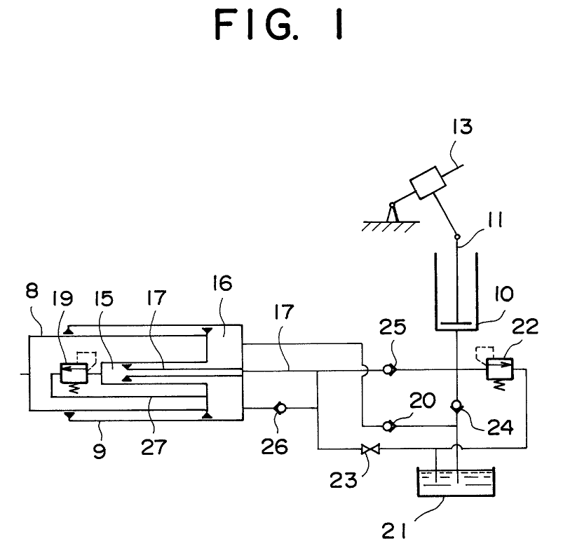

As shown in FIG. 1, a hydraulic cylinder 9 is constructed as a dual cylinder mechanism including a low pressure chamber 15 of a small effective cross-sectional area relative to a piston 8 in an inner cylinder and a high pressure chamber 16 of a large effective cross-sectional area in an outer cylinder. A hydraulic fluid channel 27 is provided connected with the low pressure chamber 15 and the high pressure chamber 16 and a sequence valve 19 is provided before the high pressure chamber 16 of the hydraulic fluid channel 27. Thus, the sequence valve 19 opens and hydraulic fluid is pumped from the low pressure chamber 15 to the high pressure chamber 16 through the sequence valve 19 when an internal pressure generated in the low pressure chamber 15 is greater than a predetermined pressure of the sequence valve 19.

In this hydraulic circuit, first, hydraulic fluid pumped from a pump cylinder 10 by operating an handle 13 via a link 11 is delivered to the low pressure chamber 15. Hydraulic fluid pumped to the low pressure chamber 15 of a small effective cross-sectional area relative to the piston 8 operates the piston 8 of the hydraulic cylinder 9, which is in a substantially no-load condition, at a high speed to raise the arm 5 provided with the support plate 4 and it is possible to quickly contact the support plate 4 to the vehicle jack point.

After contacting the support plate 4 of the arm 5 to the jack point, a load for lifting the automotive vehicle is applied to the piston when further operating the handle 13 and the pressure of hydraulic fluid in the low pressure chamber 15 increases. When the pressure in the low pressure chamber 15 exceeds a predetermined pressure of the sequence valve 19 provided in the hydraulic fluid channel 27 connected in-line with the low pressure chamber 15 and the high pressure chamber 16, the sequence valve 19 opens and hydraulic fluid is fed from the low pressure chamber 15 to the high pressure chamber 16 and the piston 8 is operated at a slow speed. Nevertheless, the pressure of the hydraulic fluid does not just merely increase, but an output of the piston increases because an aggregate effective cross-sectional area of the low pressure chamber 15 and high pressure chamber 16 is increased, and it is possible to raise an object to be lifted, an automotive vehicle. Moreover, a hydraulic fluid channel for intake provided with a check valve 20 is provided between the high pressure chamber 16 and an oil tank 21, and even when the piston 8 is moved by the hydraulic fluid delivered to the low pressure chamber 15 to increase the volume of the high pressure chamber 16, a vacuum is not caused in the high pressure chamber 16 because hydraulic fluid may be drawn into the high pressure chamber 16 from the oil tank 21 via the hydraulic fluid channel for intake.

In the garage jack according to the present invention, the hydraulic cylinder employs the dual cylinder mechanism and because the substantially no-load operation of raising the arm from the lowest height of the support plate to the jack point is performed by the inner cylinder comprising the low pressure chamber 15, the operating convenience is increased by decreasing the operating frequency of the handle. Also, since the hydraulic fluid channel 27 is provided connected in-line with the low pressure chamber 15 and the high pressure chamber 16 and the sequence valve 19 is provided in the hydraulic fluid channel 27, by continuing to operate the handle 13 after the support plate 4 contacts the vehicle jack point, the pressures in the low pressure chamber 15 comprising the inner cylinder and the high pressure chamber 16 comprising the outer cylinder are raised together and the automotive vehicle may be raised.

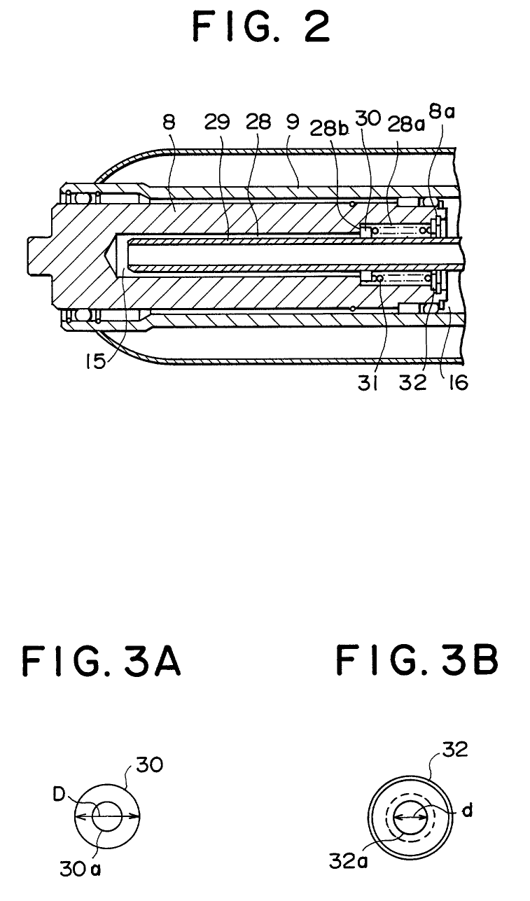

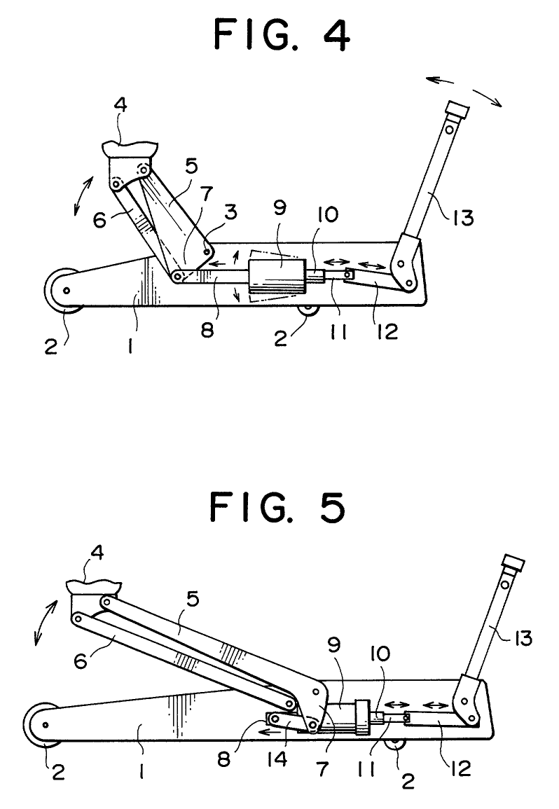

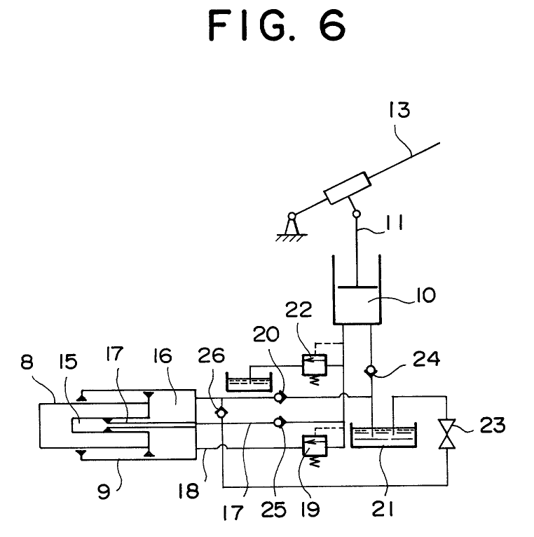

Moreover, the sequence valve 19 opens in a case where, during operation of the inner cylinder comprising the low pressure chamber 15 only, some sort of load occurs on the arm 5 and pressure of the hydraulic fluid in the low pressure chamber 15 suddenly surges beyond the predetermined pressure limit of the sequence valve 19. And, since hydraulic fluid may be automatically fed from the low pressure chamber 15 to the high pressure chamber 16, the inner cylinder of the garage jack, that is the components of the low pressure chamber 15, may be prevented from being damaged. For example, in the hydraulic cylinder shown in FIG. 2, even if the load of an automotive vehicle is applied to the support plate 4 when hydraulic fluid is being supplied to the low pressure chamber 15 only, localized pressure in the low pressure chamber 15 of the inner cylinder and in/on components thereof such as a supply pipe 29, a packing 30, a spring 31 and a presser bar 31 does not increase because the pressure in the low pressure chamber 15 and the high pressure chamber 16 increase simultaneously. Accordingly, these components are not damaged.

Also, in the garage jack according to the present invention, it is possible to provide the sequence valve 19 in the piston, and since the sequence valve 19 is not provided in a bed of the garage jack, a fabrication of the garage jack bed, in particular, a fabrication for forming a hydraulic circuit to the bed is facilitated. Accordingly, it is possible to provide a simple garage jack in which the fabrication of the hydraulic circuit is facilitated; the garage jack is equipped with a rapid traverse function from the lowest height of the support plate to the jack point, and, in the operation of lifting an automotive vehicle by means of the garage jack, the low pressure chamber 15 and components thereof are not damaged even when an external load is applied to the support plate while hydraulic fluid is being supplied to the low pressure chamber.

As shown in FIG. 2, in a preferred example of a sequence valve of the present invention, a stepped opening 28 of an appropriate diameter is formed in the piston 8 of the hydraulic cylinder 9, and a supply pipe 29 fixed to the jack bed (not shown) is inserted in the stepped opening in order to supply hydraulic fluid. The low pressure chamber 15 is formed between ends of the stepped opening 28 and the supply pipe 29, and a hydraulic fluid channel from the low pressure chamber 15 to the high pressure chamber 16 is formed by a gap between an inner circumferential surface of the stepped opening 28 and an outer circumferential surface of the supply pipe 29.

Switching between the low pressure chamber 15 and the high pressure chamber 16 is performed by a step portion 28b and the annular packing 30 or gasket fitted to an outer circumference of the supply pipe 29 at the position of an expanded portion 28a of the stepped opening 28. As shown in FIG. 3(A), the annular packing 30 includes a central opening 30a capable of being slidingly fitted to an outer circumference of the supply pipe 29. An outer diameter D of the annular packing 30 is smaller than an inner diameter of the expanded portion 28a of the stepped opening 28 and a passage for hydraulic fluid is formed between an outer circumferential surface of the annular packing 30 and an inner circumferential surface of the expanded portion 28a of the stepped opening 28. A circumferential groove 8a is formed at an end of the expanded portion 28a of the stepped opening 28 formed in the piston 8, and the annular packing 30 is pressed by means of a compression spring 31 inserted between an annular presser bar 32 fixed thereat to the step portion 28b formed at a boundary of the expanded portion 28a of the stepped opening 28 to seal the hydraulic fluid channel. Moreover, as shown in FIG. 3(B), a diameter of a central opening 32a formed in the annular presser bar 32 is smaller than an inner diameter of the compression spring 31 and larger than an outer diameter of the supply pipe 29. Accordingly, the presser bar supports the compression spring 31 and forms a hydraulic fluid channel from the low pressure chamber 15 to the high pressure chamber 16 between the central opening 32a thereof and an outer circumferential surface of the supply pipe 29.

Hydraulic fluid pumped by the pump cylinder 10 by operating the handle 13 travels through the supply pipe 29 fixed to the garage jack bed and is delivered to the low pressure chamber 15. The pressure in the low pressure chamber is low in a condition where there is substantially no-load on the piston 8 of the hydraulic cylinder 9, and the hydraulic fluid channel connecting the low pressure chamber 15 and the high pressure chamber 16 is sealed by the force of the spring 31 pressing the packing 30 against the step portion(s) 28b of the stepped opening, and the hydraulic fluid moves the piston 8 at a high speed and low output.

When the support plate contacts the jack point and a load is applied to the piston 8 of the hydraulic cylinder 9, the pressure in the low pressure chamber 15 increases, and the packing 30 retreats when a force acting on the packing 30 due to this pressure exceeds a force of the compression spring 31 pressing the packing 30 against the step portion 28b. The hydraulic fluid passes around an outer circumference of the supply pipe 29, between the step portion 28b and the packing 30, between an outer circumferential surface of the packing and an inner circumferential surface of expanded portion 28a and between the central opening 32a of the presser plate 32 and an outer circumferential surface of the pipe, and is fed into the high pressure chamber 16 and the piston 8 moves at a low speed and a high output.

Moreover, a force F of the compression spring 31 is selected to be greater than a force F1 which acts on the packing 30 due to a pressure P1 in the low pressure chamber 15 in the condition where substantially no-load acts on the arm. Namely, when F1<F, the hydraulic fluid channel is sealed by the packing 30 and since hydraulic fluid from the pump cylinder 10 is fed to the small volume low pressure chamber 15 only, the piston 8 may be moved at a high speed and a low output. In a condition where there is a load on the piston 8, the pressure P1 of the hydraulic fluid in the low pressure chamber 15 increases. The force Fl due to this pressure P1 increases and F1>F, and the packing is forced to retreat back and hydraulic fluid is pumped to the high pressure chamber 16.

When a pressure P2 in the high pressure chamber 16 roughly equals the pressure P1 in the low pressure chamber 15, a resultant force F2+F of the force F of the compression spring 31 and a force F2 acting on the packing 30 due to the pressure P2 in the high pressure chamber 16 exceeds the force F1 acting on the packing 30 due to the pressure P1 in the low pressure chamber 15, and the resultant force F2+F causes the packing 30 to seal the hydraulic fluid channel once again. Furthermore, when the pressure P1 of the hydraulic fluid in the low pressure chamber 15 increases and F1>F2+F, the packing 30 retreats and hydraulic fluid is delivered to the high pressure chamber 16. The pressure P2 of hydraulic fluid in the high pressure chamber 16 is sequentially increased by repeating this operation, and when a force acting on the piston due to the pressure P2 in the high pressure chamber 16 becomes greater than the load, the piston moves at a slow speed and a high output and it is possible to lift the load, an automotive vehicle.

In the garage jack according to the present invention in which the hydraulic cylinder includes a dual cylinder mechanism and the operating frequency is not increased when operating the handle to raise the support plate from its lowest position to the jack point in a no-load condition, the hydraulic fluid channel provided with the sequence valve is provided in connection with the low pressure chamber and high pressure chamber of the hydraulic cylinder, and when the pressure of hydraulic fluid is greater than a predetermined value of the sequence valve, the hydraulic fluid is fed from the low pressure chamber to the high pressure chamber. Thus, there is no concern that the garage jack will be damaged even if a large load occurs on the arm provided with the support plate while hydraulic fluid is being supplied to the low pressure chamber, and the working of a hydraulic circuit to the bed of the garage jack may be simplified.

Many changes and modifications in the above embodiment of the invention can be carried out without departing from the scope thereof. Accordingly, the invention is intended to be limited only by the scope of the appended claims.

What is claimed is:

1. A garage jack comprising,
a movable frame provided with wheels, an arm pivotably supported at said frame and having a support plate at an end thereof, a hydraulic cylinder for operating said arm up-and-down, said hydraulic cylinder comprising a dual cylinder mechanism comprising a low pressure chamber of a small effective cross-sectional area relative to a piston and a high pressure chamber of a large effective cross-sectional area, a pump cylinder for supplying hydraulic fluid to said hydraulic cylinder and a handle for operating said pump cylinder wherein,
a hydraulic fluid channel provided with a sequence valve is provided connected in-line with said low pressure chamber and said high pressure chamber, and in a case where a pressure of hydraulic fluid in said low pressure chamber is greater than a predetermined pressure of said sequence valve, said hydraulic fluid in said low pressure chamber is fed to said high pressure chamber.

2. A garage jack according to claim 1 wherein,
said hydraulic fluid channel provided with said sequence valve provided connected in-line with said low pressure chamber and said high pressure chamber is disposed in said piston of said hydraulic cylinder.

3. A garage jack according to claim 1 or 2 wherein,
said sequence valve comprises a stepped opening formed in said piston of said hydraulic cylinder, a packing for sealing between said stepped opening and a hydraulic fluid supply pipe, and a spring for pressing said packing to a step portion of said stepped opening.

4. A garage jack according to any one of claims 1 to 3 wherein,
a hydraulic fluid channel provided with a check valve is provided between said high pressure chamber and an oil tank to prevent a vacuum in said high pressure chamber.
